(19) United States
(12) Patent Application Publication
(10) Pub. No.: US 2024/0155978 A1
(43) Pub. Date: May 16, 2024

(54) HEDGE TRIMMERS HAVING ROTATABLE HANDLES

(71) Applicant: Milwaukee Electric Tool Corporation, Brookfield, WI (US)

(72) Inventors: Scott J. Collins, Mequon, WI (US); Brian A. Merklein, Hardford, WI (US); Eric J. Boticki, Racine, WI (US); Vishvajeet M. Ghorpade, Milwaukee, WI (US); Samuel J. Howard, Green Bay, WI (US)

(21) Appl. No.: 18/503,533

(22) Filed: Nov. 7, 2023

Related U.S. Application Data
(60) Provisional application No. 63/424,608, filed on Nov. 11, 2022.

(51) Int. Cl. A01G 3/053

(52) U.S. Cl. CPC A01G 3/053

(57) ABSTRACT

Hedge trimmers are provided. A hedge trimmer includes an elongated blade assembly; a housing comprising a base portion rotatably connected to a handle portion; a motor disposed in the housing and operable to actuate the elongated blade assembly; and an actuator disposed on the housing, wherein actuation of the actuator causes the motor to actuate the elongated blade assembly.

### PRIORITY STATEMENT

The present application claims the benefit of priority to U.S. Provisional Patent Application Ser. No. 63/424,608, filed on Nov. 11, 2022, the disclosure of which is incorporated by reference herein in its entirety.

### FIELD

The present disclosure relates generally to power tools, and more particularly, to power tools including a housing with a rotatable handle portion.

### BACKGROUND

Power tools are generally utilized to more efficiently perform work as compared to hand tools. However, this efficiency comes with certain drawbacks. For instance, because power tools allow operators to move more quickly, they allow for greater deviance in tolerances and less ergonomic handling configurations. By way of example, hedge trimmers allow operators to trim bushes, hedges and other branchy structures significantly faster than hand clippers. As a result, operators may move, rotate, or otherwise manipulate the hedge trimmer to adjust the cutting plane while trimming. Operators may also adjust the cutting plane on extended reach or pole hedge trimmers when trimming foliage high off the ground or otherwise far away from the operator.

Accordingly, improved housings for power tools are desired in the art. In particular, housings for power tools which provide a rotatable handle portion would be advantageous.

### BRIEF DESCRIPTION

Aspects and advantages of the invention in accordance with the present disclosure will be set forth in part in the following description, or may be obvious from the description, or may be learned through practice of the technology.

In accordance with one embodiment, a hedge trimmer is provided. The hedge trimmer includes an elongated blade assembly; a housing comprising a base portion rotatably connected to a handle portion; a motor disposed in the housing and operable to actuate the elongated blade assembly; and an actuator disposed on the housing, wherein actuation of the actuator causes the motor to actuate the elongated blade assembly.

In accordance with another embodiment, an extended reach hedge trimmer is provided. The extended reach hedge trimmer includes an elongated blade assembly; a pole connected to the elongated blade assembly at first end of the pole; a housing connected to the pole at a second end of the pole, the housing comprising a handle portion disposed between a base portion and a top portion, wherein the handle portion is rotatable with respect to the base portion and the top portion; a motor disposed in the housing and operable to actuate the elongated blade assembly; and an actuator disposed on the housing, wherein actuation of the actuator causes the motor to actuate the elongated blade assembly.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1A is top view of hedge trimmer in accordance with embodiments of the present disclosure;

FIG. 1B is side view the hedge trimmer illustrated in FIG. 1A in accordance with embodiments of the present disclosure;

FIG. 2 is a top view of an elongated blade assembly for a hedge trimmer in accordance with embodiments of the present disclosure;

FIG. 3A is a top view of a housing for a hedge trimmer in accordance with embodiments of the present disclosure;

FIG. 3B is a side view of the housing illustrated in FIG. 3A in accordance with embodiments of the present disclosure;

FIG. 4A is a top interior view of a housing for a hedge trimmer in accordance with embodiments of the present disclosure;

FIG. 4B is a side interview view of the housing illustrated in FIG. 4A in accordance with embodiments of the present disclosure;

FIG. 5 is a rotational locking switch for a housing of a hedge trimmer in accordance with embodiments of the present disclosure;

FIG. 6 is an interior perspective view of a portion of a housing for a hedge trimmer in accordance with embodiments of the present disclosure;

FIG. 7A is a housing for a hedge trimmer with a handle portion rotated to a center position in accordance with embodiments of the present disclosure;

FIG. 7B is a housing for a hedge trimmer with a handle portion rotated to a right position in accordance with embodiments of the present disclosure; and

FIG. 7C is a housing for a hedge trimmer with a handle portion rotated to a left position in accordance with embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive- or and not to an exclusive-or. For example, a condition A or B is satisfied by any one of the following: A is true (or present) and B is false (or not present), A is fake (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

As used herein, the term “power tool” is intended to refer to a device which is used to perform a work operation, such as cutting materials like wood, metal, concrete, grass, or the like; trimming objects like branches; biasing fluids like air and water; and the like. By way of non-limiting example, power tools can include hedge trimmers, chainsaws, circular saws, reciprocating saws, grinders, pruners, string trimmers, lawnmowers, edgers, blowers, vacuums, snow throwers, mixers, augers, pumps, pipe threaders, drills, and impact wrenches. While embodiments provided below are directed to hedge trimmers, one or more components of the hedge trimmer described below, such as the housing portion with a base portion rotatably connected to a handle portion, may be utilized with one or more different types of power tools. Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

As used herein, the terms “actuate” and its variants are intended to refer to any physical manipulation of a component. Actuation can include, for example, depressing, switching, or pushing a trigger or button. Actuation can also include, for example, reciprocating, rotating, or translating a working element such as one or more blades, saws, or bits.

In general, hedge trimmers can be used by an operator to trim bushes, hedges and other branchy structures significantly faster than hand clippers. A motor may be selectively activated to actuate one or more blades for cutting operations. Extended reach hedge trimmers can include a pole distancing the blades from the operator to enable trimming at farther locations, such as elevated tree branches. However, manipulation of the hedge trimmer to alter the cutting plane may place the operator in an uncomfortable or non-ergonomic position. As such, hedge trimmers are provided herein to include a rotatable housing portion that allows the operator to maintain a natural, or otherwise convenient, holding posture while the hedge trimmer is manipulated into a new cutting plane orientation.

The housing of the hedge trimmer thereby includes a base portion and a handle portion, wherein the handle portion is rotatably connected to the base portion. The base portion may contain bulkier elements such as the motive device and/or power source. Conversely, the handle portion may define a more tapered or narrow profile to facilitate gripping by the operator. As such, the handle portion may further contain an actuator for selectively activating the motor. When the operator wants to adjust the cutting plane of the blades, the handle portion of the housing can be selectively rotated with respect to the base portion (and the overall hedge trimmer) such that the operator's hands can still hold a suitable posture while operating the hedge trimmer with the new cutting plane orientation.

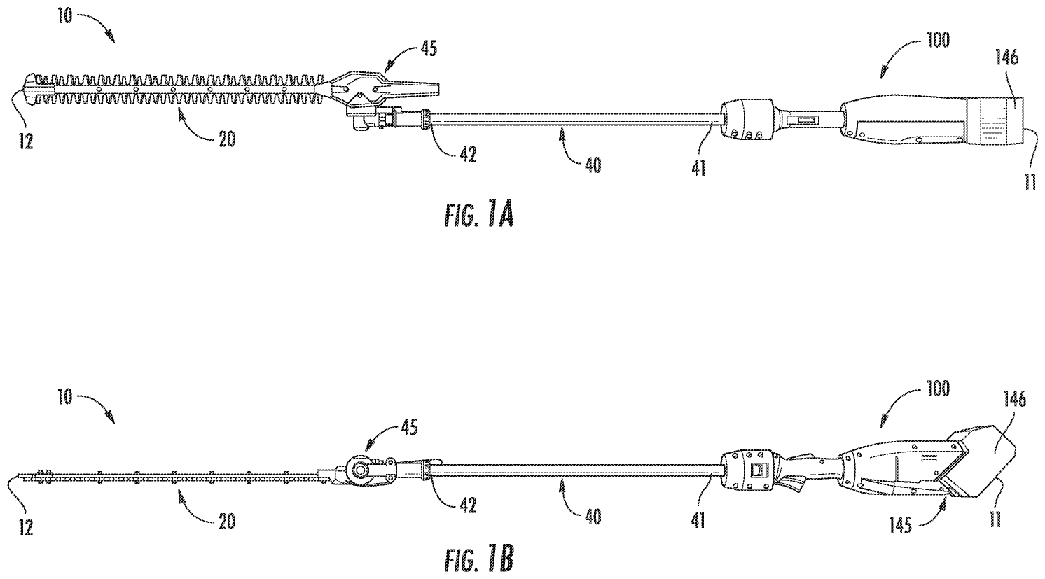

Referring now to the drawings, FIGS. 1A and 1B illustrate top and side views, respectively, of a hedge trimmer 10 in accordance with an exemplary embodiment of the present disclosure. The hedge trimmer 10 can generally include a housing 100 and an elongated blade assembly 20. The housing 100 can be located at or proximate a first end 11 of the hedge trimmer 10, while the elongated blade assembly 20 can be located at or proximate a second end 12 of the hedge trimmer 10, opposite the first end 11. The hedge trimmer 10 can further include a motive device (not illustrated) such as an electric motor or a gas engine. For instance, in the depicted embodiment, the hedge trimmer 10 includes a battery receiving area 145 which receives a battery 146 to power an electric motor. An electric motor can thereby drive the elongated blade assembly 20.

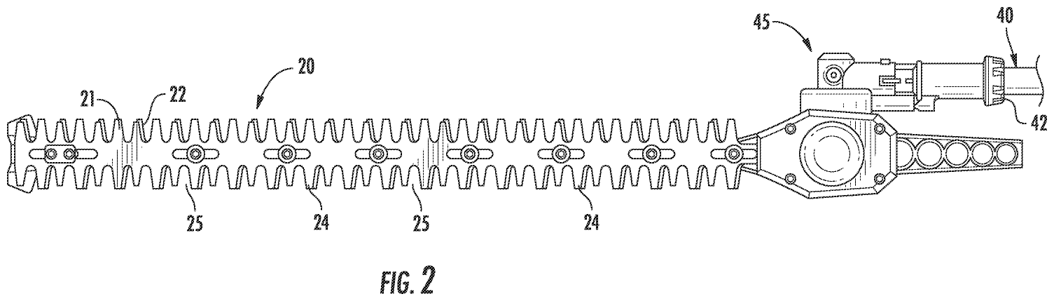

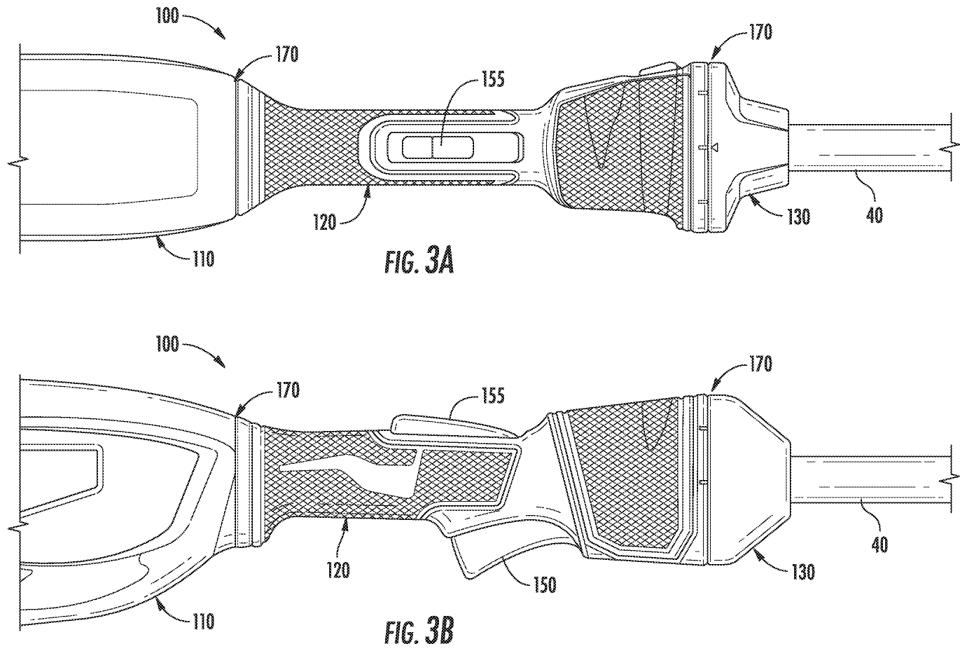

With reference to FIG. 2, a more detailed top view of the elongated blade assembly 20 is illustrated, such as for utilization with the hedge trimmer 10 illustrated in FIGS. 1A and 1B. The elongated blade assembly 20 can generally include a one or more blades, e.g., a first blade 21 and a second blade 22, that move relative to one another. At least one of the first blades 21 or second blades 22 can move in a reciprocating manner. The first blade 21 and the second blade 22 can each comprise a plurality of teeth 24 separated by gaps 25 therebetween. Cutting edges disposed along adjacent teeth 24 can thereby cut material introduced into the gaps 25 disposed between the teeth 24 as the elongated blade assembly 20 moves.

In some embodiments, such as that illustrated in FIGS. 1A and 1B, the cutting edges of the teeth 24 can be disposed along a single plane to perform a planar cut when moved in a single direction. That is, for example, an object being cut, e.g., a bush, can achieve a generally planar surface under certain operating conditions. However, further blade designs and configurations may be incorporated within the scope of this disclosure. For instance, a different number of blades may be applied, a different configuration of teeth may be incorporated, and different actuation directions may be utilized to perform cutting operations.

With reference back to FIGS. 1A and 1B, the elongated blade assembly 20 can be functionally connected to the housing 100, and the motive device, through a variety of potential configurations. For instance, as illustrated in FIGS. 1A and 1B, the hedge trimmer may comprise a pole 40 between the housing 100 and the elongated blade assembly 20. In such embodiments, the hedge trimmer 10 may be referred to as an extended reach hedge trimmer or a pole hedge trimmer. The pole 40 can comprise a variety of configurations to physically and operably connect the elongated blade assembly 20 with the housing 100, while also distancing the elongated blade assembly 20 from the housing 100. For instance, as illustrated in FIGS. 1A and 1B, the pole 40 can comprise an elongated linear structure that extends from a first end 41 to a second end 42. The first end 41 can be connected or attached to the housing 100 through one or more clamps, screws, bolts or other securing devices. The second end 42 can be connected to the elongated blade assembly 20. In some embodiments, the pole 40 may comprise a non-linear configuration and/or a movable configuration to provide more positioning or maneuverability options between the housing 100 and the elongated blade assembly 20.

The pole 40 can be a separable element from the elongated blade assembly 20 and/or the housing 100, or can be an integral extension from one or both of the elongated blade assembly 20 and housing 100. Moreover, the pole 40 can, for example, comprise a hollow interior that allows one or more mechanical or electrical connections between the housing 100 and the elongated blade assembly 20. For instance, if the motive device is disposed in the housing 100, an axle or similar device may extend down the pole 40 to translate actuation (e.g., rotational motion) from the motive device to the elongated blade assembly 20. Alternatively, if the motive device were disposed at, near, or on the elongated blade assembly 20, a power and/or communication coupling (e.g., wires or cables) may extend down the pole 40 to translate electrical power and/or control signals from the housing for operating the elongated blade assembly 20.

In some embodiments, such as that illustrated in FIGS. 1A, 1B, and 2, the pole 40 may comprise an attachment feature 45 for selectively attaching the elongated blade assembly 20 thereto. For instance, the attachment feature 45 may selectively receive and secure the elongated blade assembly 20 at one of a plurality of orientations through rotational flexibility and selective clamping. Thus, the elongated blade assembly 20 can be selectively positioned by the operator prior to operation to put the elongated blade assembly 20 in a linear configuration (as illustrated) that is aligned with the pole 40, or in an offset configuration wherein the elongated blade assembly deviates from the pole 40 at an angle.

The elongated blade assembly 20, whether extending directly or indirectly from the housing 100, can lie along a plane. The plane of the elongated blade assembly 20 may be referred to as the cutting plane. The cutting plane can generally maintain a fixed relationship with respect to at least a portion of the housing 100 during operation of the hedge trimmer 10. Thus, as the housing 100 is manipulated by the operator, e.g., as a relative angle of the housing 100 is changed through manipulation or input exhibited by the operator, the elongated blade assembly 20 can move by a generally similar angular displacement. It should be understood that some deviation between the elongated blade assembly 20 and housing 100 may be attributable, e.g., to deflection in the elongated blade assembly 20 or tolerance at an interface between the elongated blade assembly 20 and the housing 100. In general, though, the elongated blade assembly 20 can have a generally fixed relationship with respect to at least a portion of the housing 100.

However, adjusting the cutting plane of the elongated blade assembly 20 by manipulating the housing 100 may put an operator in an inconvenient position, particularly when the hedge trimmer is in an extended reach configuration. Therefore, as disclosed herein, the housing 100 may have one or more rotational components to enable an operator to both rotate an overall housing 100 to adjust the cutting plane of the elongated blade assembly 20, while separately rotating or adjusting a handle portion of the housing 100 to maintain the operator's hands and overall grip in a more convenient posture.

Referring now to FIGS. 3A and 3B, top and side views are illustrated, respectively, of a portion of the housing 100, such as for utilization with the hedge trimmer 10 illustrated in FIGS. 1A and 1B.

The housing 100 generally includes a base portion 110 and a handle portion 120, wherein the base portion 110 is rotatably connected to the handle portion 120. The housing 100 can further comprise one or more components to power, control, or otherwise facilitate operation of the hedge trimmer 10. By providing a rotatable connection between the base portion 110 and the handle portion 120 of the housing 100, an operator may adjust his or her grip position on the housing 100 comprising one or more operational components while using the overall hedge trimmer 10.

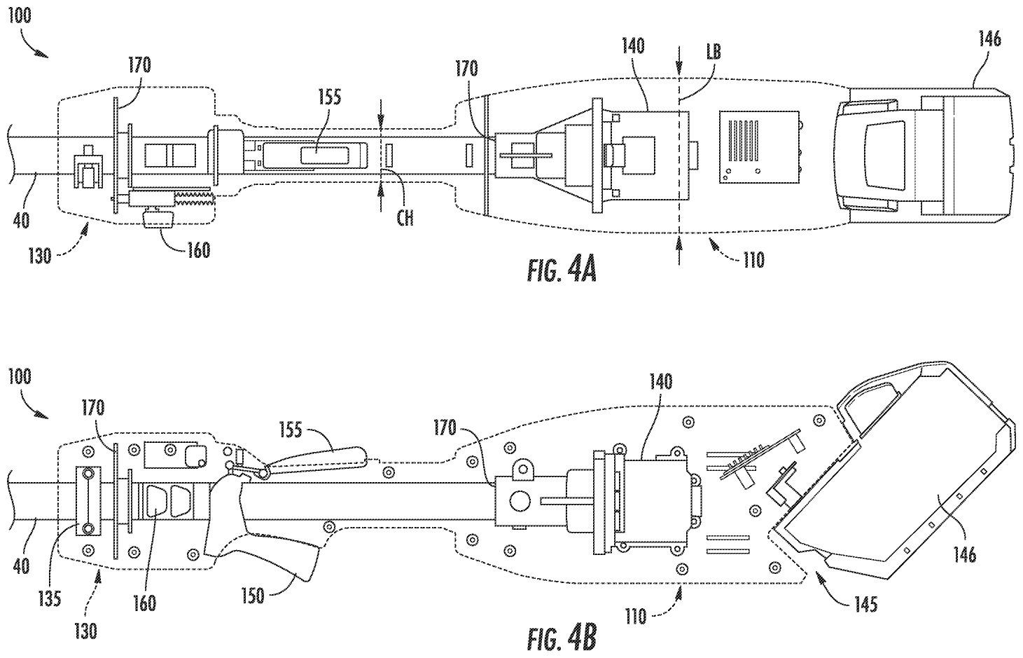

The base portion 110 can comprise a first portion of the housing 100, such as a portion that may comprise a motive device and/or power supply. For instance, the base portion 110 of the housing 100 may be the portion that is closest to the first end 11 of the hedge trimmer 10, and thus furthest from the elongated blade assembly 20 (as illustrated in FIGS. 1A and 1B). With additional reference to FIGS. 4A and 4B, top and side views are illustrated, respectively, of the housing 100 to illustrate one or more of the exemplary components that can be associated with one or more parts of the housing 100. For instance, as illustrated, the base portion 110 may comprise a motor 140. The motor 140 can comprise any device suitable for actuating the elongated blade assembly 20 of the hedge trimmer 10, such as an electric motor (as illustrated) or a gas engine. The base portion 110 may further comprise a power supply system for the motor 140. For instance, the base portion 110 may comprise a battery receiving area 145 for selectively receiving one or more batteries 146 for powering the motor 140. The one or more batteries 146 can be rechargeable batteries, single use batteries, or combinations thereof.

The handle portion 120 can comprise a second portion of the housing 100, such as a portion that may be gripped by an operator when using the hedge trimmer 10. For instance, the handle portion 120 may be next to the base portion 110 in the direction towards the second end 12 of the hedge trimmer 10, and thus towards the elongated blade assembly 20 (as illustrated in FIGS. 1A and 1B). The handle portion 120 may also be configured to be gripped by the operator when using the hedge trimmer 10. For instance, the base portion 110 may comprise a first cross sectional diameter CB that is perpendicular to the longitudinal axis L of the housing 100, wherein the longitudinal axis L runs down the length of the hedge trimmer from the housing 100 to the elongated blade assembly 20. Likewise, the handle portion 120 can comprise a second cross sectional diameter CH that is perpendicular to the longitudinal axis L of the housing 100. The second cross sectional diameter CH of the handle portion 120 can be smaller than the first cross sectional diameter CB of the base portion 110 to provide a more narrow and tapered grip area for the operator. Moreover, the relatively larger base portion 110 may also provide additional balance to the hedge trimmer by positioning a larger section of the housing (potentially with heavier components like the motor 140 and battery 146) on the opposite side of the operators grip than the elongated blade assembly 20. However, while the hedge trimmer 10 is illustrated as having the handle portion 120 between the base portion 110 and the elongated blade assembly 20, it should be appreciated that the hedge trimmer 10 may alternatively comprise a housing 100 having the base portion 110 between the handle portion 120 and the elongated blade assembly 20.

Similar to the base portion 110, the handle portion 120 can comprise one or more of the components that can be associated with the one or more parts of the housing 100. For instance, as illustrated, the handle portion 120 may comprise an actuator 150. The actuator 150 can be any component configured to selectively activate the motor 140 such that the motor 140 actuates (e.g., reciprocates) the elongated blade assembly 20. The actuator 150 can comprise a trigger (as illustrated) or other suitable component such as a button, knob, wheel, or sensor. As such, the operator of the hedge trimmer 10 may grip the housing 100 via the handle portion 120 while conveniently operating the hedge trimmer (i.e., turning movement of the elongated blade assembly 20 on and off for cutting operations) via the actuator 150 disposed on the handle portion 120.

In some embodiments, the housing 100 may further comprise a safety trigger 155 that acts in cooperation with the actuator 150 to operate the motor 140. For instance, the safety trigger 155 may need to be depressed or otherwise selected before the actuator 150 can be actuated. The safety trigger 155 can thereby inhibit inadvertent or undesired operation of the elongated blade assembly 20 from accidental interaction with the actuator 150. The safety trigger 155 can be disposed on the handle portion 120 similar to the actuator 150 to facilitate single handed control operations of the hedge trimmer 10. For instance, the actuator 150 may be disposed on a bottom side of the handle portion 120 while the safety trigger 155 can be located on the top side of the handle portion 120, opposite the actuator 150. As such, an operator may naturally depress the safety trigger 155 when gripping the handle portion. The operator may then selectively depress the actuator 150 in a trigger like configuration while remaining gripped on the handle portion 120. However, it should be appreciated, that additional or alternative configurations of the actuator 150, safety trigger 155, or other components may also be realized within the scope of this disclosure.

With reference to FIGS. 3A-4B, in some embodiments, such as that illustrated, the housing 100 may further comprise a top portion 130. The top portion 130 can comprise an additional portion of the housing 100 such as to support or otherwise connect adjacent components such as the pole 40 or elongated blade assembly 20 (FIGS. 1A and 1B). For instance, the top portion 130 of the housing 100 can be next to the handle portion 120 in the direction towards the second end 12 of the hedge trimmer 10, and thus towards the elongated blade assembly 20 (as illustrated in FIGS. 1A and 1B). As such, the handle portion 120 can be disposed between the base portion 110 and the top portion 130 with rotatable connections therebetween. Moreover, while the handle portion 120 may be rotatable with respect to the base portion 110 and the top portion 130, the base portion 110 and top portion 130 may both be fixed with respect to one another so that their relative orientation does not change.

When present, the top portion 130 can help provide additional support or components for the hedge trimmer 10. For instance, in some embodiments, the top portion 130 may comprise a forward clamp 135. The forward clamp 135 can secure the pole 40, the elongated blade assembly 20, or other interconnected components to the housing 100. The forward clamp 135 may thereby selectively receive and release the pole 40, for example, for assembly or maintenance operations of the hedge trimmer 10. In some embodiments, the pole 40 may thereby extend through at least the top portion 130 of the housing. As illustrated in FIGS. 4A and 4B, the pole 40 may extend through the top portion 130, the handle portion 120, and into the base portion 110. As such, the motor 140 disposed in the base portion 110 can directly engage with the pole 40 (such as an axle in the pole 40) for downstream mechanical control of the elongated blade assembly 20.

With reference back to FIGS. 4A and 4B, the housing 100 comprises one or more rotational connections 170. The rotational connections 170 can be between adjacent portions of the housing 100 to enable selective rotation therebetween about a longitudinal axis L. For instance, the housing 100 can comprise a first rotational connection 170 between the base portion 110 and the handle portion 120 and a second rotational connection 170 between the handle portion 120 and the top portion 130.

The rotational connection 170 can comprise any mechanical connection that joins adjacent portions of the housing 100 while allowing rotation therebetween. For instance, the rotational connection 170 may comprise two plates that may rotate with respect to one another unless fixed together or in place. Alternatively, or additionally, the rotational connection 170 may comprise abutting or nested pipes or poles that can rotate relative to one another. In some embodiments, the rotational connection 170 may also comprise additional movement directions, such as both rotational movement and tilting movement. Such embodiments my involve the use of one or more universal joints or other suitable connections that allow movement in multiple directions. Moreover, the housing 100 can use the same types of rotational connections 170 at different locations, or may use different types of rotational connections 170 at different locations.

In some embodiments, the handle portion 120 may be able to rotate at least 90 degrees with respect to the base portion 110. In some embodiments, the handle portion 120 may be able to rotate at least 180 degrees with respect to the base portion 110. In even some embodiments, the handle portion may be able to rotate 360 degrees with respect to the base portion 110. Moreover, the rotational ability between the handle portion 120 may be unidirectional or bidirectional.

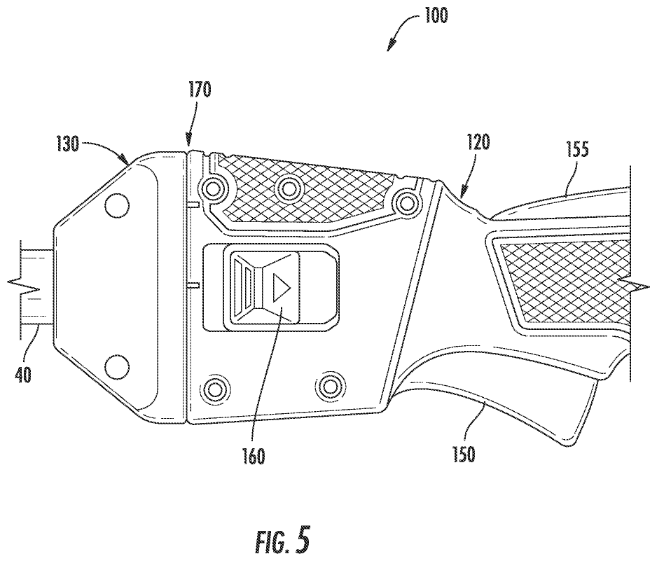

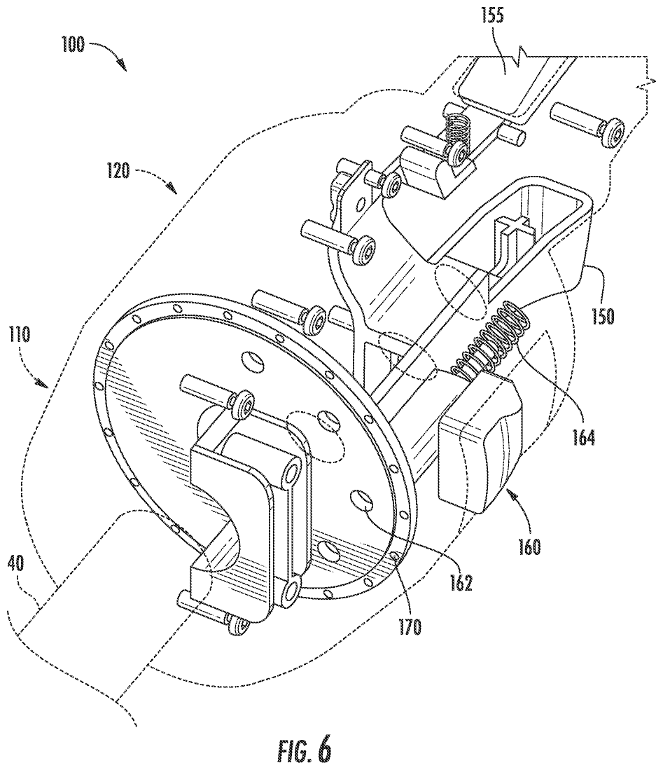

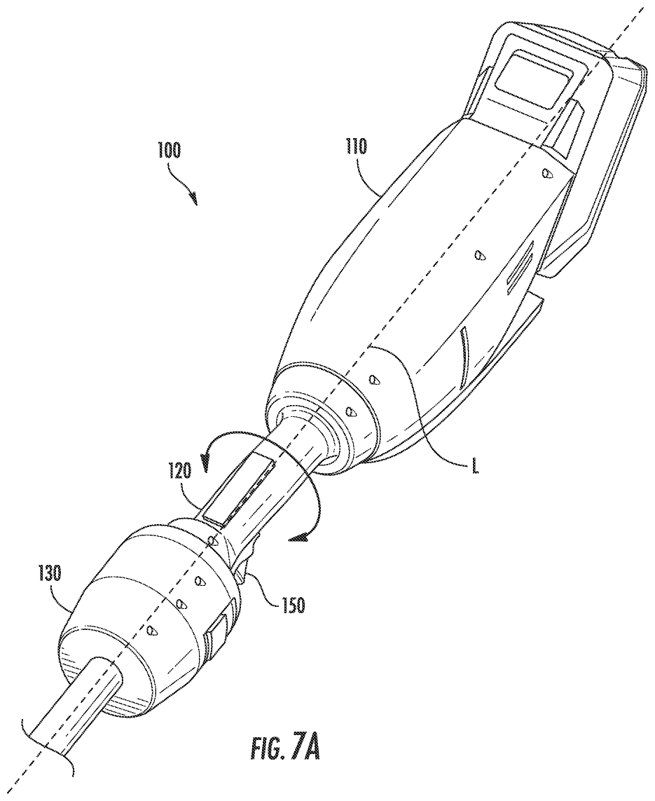

With reference to FIGS. 5 and 6, a portion of the housing 100 is illustrated with an optional rotational locking switch 160. In accordance with the disclosure herein, the rotational locking switch 160 may selectively lock and release the rotational ability of the handle portion 120 of the housing 100 with the base portion 110 and/or the top portion 130. For instance, the rotational locking switch 160 may be located at a side of the top portion 130 as illustrated. Before the operator wants to rotate the handle portion 120, the operator may need to actuate the rotational locking switch 160 into an unlocked position. Then, while the rotational locking switch 160 is in the unlocked position, the operator may selectively rotate the handle portion 120 with respect to the base portion 110 and/or top portion 130 of the housing 100 to a desired orientation. After the handle portion 120 is rotated into the desired configuration, the operator may return the rotational locking switch 160 to a locked position, such as by simply releasing the rotational locking switch which is naturally biased to return to the locked position, or physically forcing the rotational locking switch back to the locked position.

For instance, as best illustrated in FIG. 6, the rotational locking switch 160 may comprise a locking pin 162 that can selectively engage a rotational connection 170 between two portions of the housing 100. When the locking pin 162 is engaged with the rotational connection 170 (as illustrated in FIG. 6), the locking pin 162 can pass through the components of the rotational connection 170 to prevent rotation therebetween. Moreover, the rotational locking switch 160 may be biased by a spring 164 that naturally pushes the locking pin 162 into the rotational connection 170 to prevent rotational movement. As such, the operator may need to force, and hold, the rotational locking switch 160 away from the rotational connection 170 to temporarily release the locking pin 162 and thereby allow rotation of the handle portion 120 relative to the top portion 130 and/or the base portion 110 of the housing 100.

While the figures herein illustrate exemplary embodiments of the housing 100, portions thereof, and associated components, it should be appreciated that these embodiments are not intended to be limiting. For instance, the motor 140 and/or the battery receiving area 145 may be located elsewhere besides the bottom portion. Moreover, instead of, or in addition to, the battery receiving area 145, the housing 100 may incorporate alternative power configurations such as a permanent battery or an auxiliary power cord connection. Likewise, the actuator 150 and/or the safety trigger 155 may be located elsewhere besides the handle portion 120, either alone or in combination. Similarly, the rotational locking switch 160 may be disposed elsewhere on the housing 100, such as on the handle portion 120 itself. Thus, while exemplary components and their locations have been shown and described herein, it should be appreciated that these are exemplary only and alternative variations may further be realized.

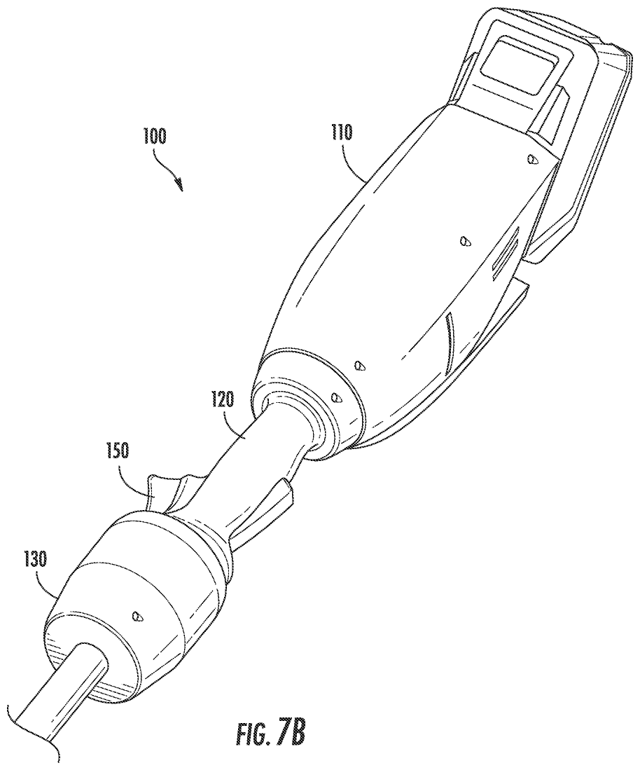

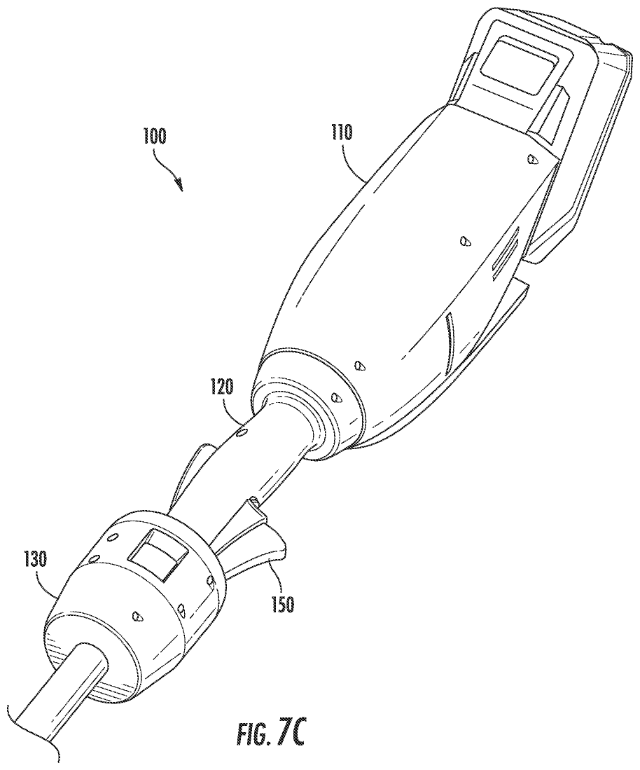

Referring now to FIGS. 7A-7C, the housing 100 is illustrated in various rotational orientations wherein the handle portion 120 is rotated about the longitudinal axis L with respect to the base portion 110 and the top portion 130. FIG. 1A illustrates the housing 100 in a centered orientation wherein the handle portion 120 is substantially centered in its rotational range, such as when the actuator 150 is directly disposed on the bottom side of the housing 100. FIG. 1B illustrates the housing 100 in a right orientation wherein the handle portion 120 is rotated to the right, such as when the actuator 150 is directly disposed on the right side of the housing 100. FIG. 1C illustrates the housing 100 in a left orientation wherein the handle portion 120 is rotated to the left, such as when the actuator 150 is directly disposed on the left side of the housing 100.

Thus, in operation, the operator of the hedge trimmer (such as illustrated in FIGS. 1A and 1B), may seek to change the cutting plane of the elongated blade assembly 20, such as when trimming contours or mitigating obstacles. However, the change in cutting plane of the elongated blade assembly 20 may inherently put the operator in an awkward position while holding the housing 100. Thus, to facilitate a more ergonomic and safer positioning, the operator may desire to rotate the handle portion 120 of the housing 100 to allow the operator's grip to remain in the same or similar position, while the rest of the housing 100 (and overall hedge trimmer 10) is turned. As such, the operators grip, including the grip's interaction with the actuator 150 and/or the safety trigger 155 can remain in the operator's natural position while the cutting plane of the elongated blade assembly changes.

Further aspects of the invention are provided by one or more of the following embodiments:

A hedge trimmer includes an elongated blade assembly; a housing comprising a base portion rotatably connected to a handle portion; a motor disposed in the housing and operable to actuate the elongated blade assembly; and an actuator disposed on the housing, wherein actuation of the actuator causes the motor to actuate the elongated blade assembly.

The hedge trimmer of any clause herein, wherein the actuator is disposed on the handle portion of the housing.

The hedge trimmer of any clause herein, wherein the motor is disposed in the base portion of the housing.

The hedge trimmer of any clause herein, wherein the handle portion comprises a smaller cross sectional diameter than the base portion.

The hedge trimmer of any clause herein, wherein the handle portion comprises a smaller cross sectional diameter than the base portion.

The hedge trimmer of any clause herein, wherein the base portion is between the handle portion of the housing and the elongated blade assembly.

The hedge trimmer of any clause herein, further comprising a safety trigger disposed on the handle portion of the housing, wherein the safety trigger selectively inhibits actuation of the actuator.

The hedge trimmer of any clause herein, wherein the housing further comprises a top portion rotatably connected to the handle portion, wherein the handle portion is disposed between the base portion and the top portion.

The hedge trimmer of any clause herein, wherein the elongated blade assembly is connected to the housing via a pole.

The hedge trimmer of any clause herein, wherein the elongated blade assembly is connected to the housing via a pole.

The hedge trimmer of any clause herein, wherein the pole extends through the handle portion and into the base portion of the housing.

The hedge trimmer of any clause herein, further comprising a rotational locking switch that selectively inhibits rotation of the handle portion.

The hedge trimmer of any clause herein, wherein the rotational locking switch is biased into a locked position.

The hedge trimmer of any clause herein, wherein the handle portion can rotate at least 90 degrees with respect to the base portion.

The hedge trimmer of any clause herein, wherein the handle portion is rotatable about a longitudinal axis running down a length of the hedge trimmer.

An extended reach hedge trimmer includes an elongated blade assembly; a pole connected to the elongated blade assembly at first end of the pole; a housing connected to the pole at a second end of the pole, the housing comprising a handle portion disposed between a base portion and a top portion, wherein the handle portion is rotatable with respect to the base portion and the top portion; a motor disposed in the housing and operable to actuate the elongated blade assembly; and an actuator disposed on the housing, wherein actuation of the actuator causes the motor to actuate the elongated blade assembly.

The extended reach hedge trimmer of any clause herein wherein the actuator is disposed on the handle portion of the housing.

The extended reach hedge trimmer of any clause herein wherein the motor is disposed in the base portion of the housing.

The extended reach hedge trimmer of any clause herein further comprising a rotational locking switch that selectively inhibits rotation of the handle portion.

The extended reach hedge trimmer of any clause herein wherein the rotational locking switch is disposed on the handle portion of the housing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A hedge trimmer comprising:
an elongated blade assembly;
a housing comprising a base portion rotatably connected to a handle portion;
a motor disposed in the housing and operable to actuate the elongated blade assembly; and
an actuator disposed on the housing, wherein actuation of the actuator causes the motor to actuate the elongated blade assembly.

2. The hedge trimmer of claim 1, wherein the actuator is disposed on the handle portion of the housing.

3. The hedge trimmer of claim 2, wherein the motor is disposed in the base portion of the housing.

4. The hedge trimmer of claim 3, wherein the handle portion is between the base portion of the housing and the elongated blade assembly.

5. The hedge trimmer of claim 4, wherein the handle portion comprises a smaller cross sectional diameter than the base portion.

6. The hedge trimmer of claim 2, wherein the base portion is between the handle portion of the housing and the elongated blade assembly.

7. The hedge trimmer of claim 2, further comprising a safety trigger disposed on the handle portion of the housing, wherein the safety trigger selectively inhibits actuation of the actuator.

8. The hedge trimmer of claim 1, wherein the housing further comprises a top portion rotatably connected to the handle portion, wherein the handle portion is disposed between the base portion and the top portion.

9. The hedge trimmer of claim 8, wherein the top portion and the base portion are not rotatable with respect to one another.

10. The hedge trimmer of claim 1, wherein the elongated blade assembly is connected to the housing via a pole.

11. The hedge trimmer of claim 10, wherein the pole extends through the handle portion and into the base portion of the housing.

12. The hedge trimmer of claim 1, further comprising a rotational locking switch that selectively inhibits rotation of the handle portion.

13. The hedge trimmer of claim 12, wherein the rotational locking switch is biased into a locked position.

14. The hedge trimmer of claim 1, wherein the handle portion can rotate at least 90 degrees with respect to the base portion.

15. The hedge trimmer of claim 1, wherein the handle portion is rotatable about a longitudinal axis running down a length of the hedge trimmer.

16. An extended reach hedge trimmer comprising:
an elongated blade assembly;
a pole connected to the elongated blade assembly at first end of the pole;
a housing connected to the pole at a second end of the pole, the housing comprising a handle portion disposed between a base portion and a top portion, wherein the handle portion is rotatable with respect to the base portion and the top portion;
a motor disposed in the housing and operable to actuate the elongated blade assembly; and
an actuator disposed on the housing, wherein actuation of the actuator causes the motor to actuate the elongated blade assembly.

17. The extended reach hedge trimmer of claim 16, wherein the actuator is disposed on the handle portion of the housing.

18. The extended reach hedge trimmer of claim 17, wherein the motor is disposed in the base portion of the housing.

19. The extended reach hedge trimmer of claim 17, further comprising a rotational locking switch that selectively inhibits rotation of the handle portion.

20. The extended reach hedge trimmer of claim 17, wherein the rotational locking switch is disposed on the handle portion of the housing.
